(19) United States
(12) Patent Application Publication
(10) Pub. No.: US 2020/0090090 A1
(43) Pub. Date: Mar. 19, 2020

(54) DISTRIBUTED LEDGER SYSTEM FOR VENTURE MANAGEMENT

(71) Applicant: Accenture Global Solutions Limited, Dublin (IE)

(72) Inventors: Hari Padmanabhan, Bangalore (IN); Garlapati Srinivas Reddy, Hyderabad (IN); Pachhipulusu Rohini Tara, Bhimavaram (IN)

(21) Appl. No.: 16/130,273

(22) Filed: Sep. 13, 2018

(51) Int. Cl. G06Q 10/06; H04L 9/06; G06F 17/30; G06F 21/62; G06Q 40/06

(52) U.S. Cl. CPC G06Q 10/0637; H04L 9/0637; G06Q 10/0631; H04L 2209/38; G06F 17/30194; G06F 21/6218; G06Q 40/06; H04L 9/0643

(57) ABSTRACT

Techniques are described for a managing a joint venture (JV) involving multiple entities, using a distributed ledger system (DLS) such as a system or network of one or more blockchains. A venture management platform can receive data associated with a (JV), the data by one or more entity computing systems in communication with the platform. The received data can describe event(s) associated with the JV involving entities that respectively operate or are associated with the entity computing systems that provide the data. The data can be stored on a (e.g., permissioned) DLS of the platform. One or more smart contract(s), which are component(s) of the platform, can execute (e.g., on the DLS) to perform action(s) based on the data and based on at least one constraint specified by a joint operating agreement (JOA) that governs the JV and that is also stored on the DLS.

### BACKGROUND

The Joint Operating Agreement (JOA) in the oil and gas industry, or in other industries, is an underlying contractual framework of a joint venture (JV). For example, in the oil and gas industry, a JOA may be a contract through which two or more parties agree to undertake a task to explore and exploit hydrocarbons in a particular region. The parties in the agreement can be broadly classified as operators and non-operators, also described herein as operating entities and non-operating entities. In some instances, a governmental agency can also be a part of such agreements. The operator may be responsible for the day-to-day operations in the field, and for expenditure management and accounting. For example, the party with highest interest can be designated as an operator and be entitled to (e.g., full) control of operations of the exploration operations. The duty of the operator may be to plan the activities to increase the profitability of the operations. In some instances, the operator may not be liable for any loss of production or revenue because of its decisions, except in instances of gross negligence or willful misconduct. Traditionally, the managerial decisions and related expenditures may be reconciled once in a period (e.g., per quarter), but by that time damage may have occurred due to mismanagement of investments. Thus, traditionally the lack of transparency of the management and loss of credibility of the operator can lead to a JOA developing problems, potentially leading to costly legal disputes and other problems.

### SUMMARY

Implementations of the present disclosure are generally directed to a distributed ledger system for venture management. More particularly, implementations of the present disclosure are directed to use of a distributed ledger system to receive and store data associated with a joint venture involving multiple entities, control entity access to the data stored on the distributed ledger system, and execute logic (e.g., a smart contract) to perform reconciliation and/or other operation(s) based on the data, according to a joint operating agreement and/or other rules incorporated into the executed logic.

In general, implementations of innovative aspects of the subject matter described in this specification can be embodied in a method that includes the following operations: receiving, at a venture management platform, venture data generated by an entity system in communication with the venture management platform, the venture data describing one or more events associated with a venture that involves multiple entities including an entity that operates the entity system; storing the venture data on a permissioned distributed ledger system (DLS) of the venture management platform, the DLS including multiple host node devices; and executing at least one smart contract that is a component of the venture management platform, the at least one smart contract performing at least one action based on the venture data and based on at least one constraint specified by an agreement that governs the venture and that is stored on the DLS.

These and other implementations can each optionally include one or more of the following innovative aspects: storing the venture data on the DLS is based at least in part on determining that the entity is authorized to access the venture management platform; the venture data is communicated with a request, from the entity system, to perform the at least one action; performing the at least one action is based at least partly on determining that the entity is of an entity type that is authorized to request the at least one action; the entity type is at least one of an operating entity involved in the venture, a non-operating entity involved in the venture, and an auditor of the venture; the at least one smart contract executes on the DLS; the at least one action includes a reconciliation between the entity and at least one other entity involved in the venture; and/or the venture management platform further includes an application layer in communication with the entity system, and a runtime environment that mediates communications between the application layer and the DLS.

Other implementations of any of the above aspects include corresponding systems, apparatus, and/or computer programs that are configured to perform the operations of the methods. The present disclosure also provides a computer-readable storage medium coupled to one or more processors and having instructions stored thereon which, when executed by the one or more processors, cause the one or more processors to perform operations in accordance with implementations of the methods provided herein. The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

The implementations described herein provide at least the following technical advantages and/or improvements compared to previously available techniques. By using a distributed ledger system for storing information regarding a venture, implementations incorporate the technical advantages of a distributed ledger including but not limited to data security, data immutability and reliability, and distributed storage (e.g., for failover support and storage redundancy). Use of a distributed ledger can also provide advantages to track and confirm data provenance, and provide data privacy.

It is appreciated that implementations in accordance with the present disclosure can include any combination of the aspects and features described herein. That is, implementations in accordance with the present disclosure are not limited to the combinations of aspects and features specifically described herein, but also include any other appropriate combinations of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example system for venture management, according to implementations of the present disclosure.

FIG. 2 depicts an example system for venture management, according to implementations of the present disclosure.

FIG. 3 depicts an example system for venture management including access to various types of records stored on a distributed ledger system, according to implementations of the present disclosure.

FIG. 4 depicts a flow diagram of an example process for venture management, according to implementations of the present disclosure.

FIG. 5 depicts an example computing system, according to implementations of the present disclosure.

### DETAILED DESCRIPTION

Implementations of the present disclosure are directed to techniques for using a distributed ledger system (DLS) for managing a venture (e.g., joint venture) involving multiple entities. In many industries, such as the oil and gas industry, enterprises can be very asset intensive and risk prone, involving large and potentially high-risk investments. Accordingly, in such industries it is not uncommon for multiple parties to form a joint venture with a common goal to share the risks and rewards in the business.

A Joint Operating Agreement (JOA) provides an underlying contractual framework for a joint venture (JV). JOAs can be extremely complex because they involve multiple parties and can be in place for decades (e.g., 15-25 years or more). In addition, a subset of partners to a JOA may have separate, and in some instances secret contracts between them that define sub-ratios for revenue allocation. For example, a JOA with parties A, B, and C may indicate that party A gets 30% of the revenue from party B, and parties A and B can also have a secret agreement that states party A will return a percentage of what it receives to party B. This secret agreement may not be known to party C. Also, the lack of visibility into specific transactions and the periodic settlement can further reduce efficiencies and can contribute to errors. Also, parties to a JV can change hands over time, which further complicates tracking.

A JOA can also specify the structure of the organization while managing the balance between variables for the underlying (e.g., hydrocarbon) assets, such as ownership, control, and risk. Historically, roughly 40% of oil and gas companies have considered or are considering using a JOA for at least some operations. While JOAs can be an integral part of the current oil and gas industry, it is estimated that 60% of JOAs fail or begin to fail within 5-8 years from their inception. There are many reasons for these failures, but the majority of JOAs fail due to inattention to command and control, and/or the incorrect representation and accounting of investments.

Implementations described herein provide a platform that can be used to address these transparency and credibility issues, and/or other problems present in traditionally managed JOAs, through integration of enterprise financial and accounting systems with a DLS, such as a system that includes one or more blockchains. Through use of a DLS, each transaction can be visible to each authorized party individually without requiring rewriting or period-end reconciliation by the operating party. In this way, the platform describes herein provides a mechanism by which operators can be prudent in their decisions and transactions. This in turn can lead to a higher probability of JOAs being successful.

Moreover, implementations can employ a DLS to convert the traditionally low trust environment of a JOA into a high trust environment. Through the use of a DLS, implementations can handle JOAs that have a hierarchy of risk/ownership allocations such as those described above. For example, the implementations can handle secret sub-ratios between two or more parties by allowing (e.g., only) the involved parties to see information about the secret agreement(s). Implementations can operate to ensure that unauthorized parties to the secret agreement cannot access the terms of the secret agreement and, in some instances, cannot know that a separate agreement exists among a subset of the parties to the JOA.

The core benefits provided by the implementations described herein can include the following: increase in the success rates of JV operations and investments; an increase in the productivity of investments, having a direct bearing on the organizational financial and/or governmental fiscal balance; increased security to prevent tampering with accounts, given that all parties can have the same transaction posted in their own ledger separately, establishing transparency and credibility; and/or transparency into the reasons for the expenditure and/or investments by all parties in real time, to enable parties to ascertain any potential risks.

In some implementations, the DLS includes one or more blockchains. A blockchain is a public or private ledger of transactions that have been executed in one or more contexts (e.g., negotiable instrument transactions, digital currency transactions, access determinations, instances of providing access, etc.). A blockchain may grow as completed blocks are added with a new set of transactions. In some examples, a single block is provided from multiple transactions (e.g., multiple deposits of different checks by different people). In general, blocks are added to the blockchain in a linear, chronological order by one or more computing devices in a peer-to-peer network of interconnected computing devices that execute a blockchain protocol. In short, the peer-to-peer network can be described as a plurality of interconnected nodes, each node being a computing device (or a cluster of multiple devices) that uses a client to validate and relay transactions. Each node maintains a copy of the blockchain, which is automatically downloaded to the node upon joining the peer-to-peer network. The blockchain protocol provides a secure and reliable method of updating the blockchain, copies of which are distributed across the peer-to-peer network, without use of a central authority.

Because all entities on the blockchain network may need to know all previous transactions to validate a requested transaction, all entities must agree on which transactions have actually occurred, and in which order. For example, if two entities observe different transaction histories, they will be unable to come to the same conclusion regarding the validity of a transaction. The blockchain enables all entities to come to an agreement as to transactions that have already occurred, and in which order. In short, and as described in further detail below, a ledger of transactions is agreed to based on the amount of work required to add a transaction to the ledger of transactions (e.g., add a block to the blockchain). Blockchains may also employ other protocols. In this context, the work is a task that is difficult for any single node (e.g., computing device) in the peer-to-peer network to quickly complete, but is relatively easy for a node (e.g., computing device) to verify.

The peer-to-peer network can include so-called miners (e.g., computing devices) that add blocks to a blockchain based on the blockchain protocol. In general, multiple miners validate transactions that are to be added to a block, and compete (e.g., perform work, as introduced above) to have their block added to the blockchain. Other suitable consensus mechanism(s) can also be employed. Validation of transactions includes verifying digital signatures associated with respective transactions. For a block to be added to the blockchain, a miner must demonstrate a proof of work before their proposed block of transactions is accepted by the peer-to-peer network, and is added to the blockchain. A blockchain protocol includes a proof of work scheme that is based on a cryptographic hash function (CHF). An example CHF includes the secure hash algorithm 256 (SHA-256). In general, the CHF receives information as input, and provides a hash value as output, the hash value being of a predetermined length. For example, SHA-256 outputs a 256-bit (32-byte, 64-character) hash value. In some examples, the hash value is a one-way hash value, in that the hash value cannot be ‘un-hashed’ to determine what the input was. The blockchain protocol can require multiple pieces of information as input to the CHF. For example, the input to the CHF can include a reference to the previous (most recent) block in the blockchain, details of the transaction(s) that are to be included in the to be created block, and a nonce value (e.g., a random number used only once).

Multiple nodes may compete to hash a set of transactions and provide the next block that is to be added to the blockchain. The blockchain protocol provides a threshold hash to qualify a block to be added to the blockchain. For example, the threshold hash can include a predefined number of zeros (0's) that the hash value must have at the beginning (e.g., at least the first four characters of the hash value must each be zero). The higher the number of zeros, the more time-consuming it is to arrive at a qualifying hash value.

In accordance with the blockchain protocol, each miner in the peer-to-peer network receives transaction information for one or more transactions that are to be included in a block that is to be added next in the blockchain. Each miner provides the reference to the previous (most recent) block in the blockchain, details of the transaction(s) that are to be included in the to-be-created block, and the nonce value to the CHF to provide a hash value. If the hash value does not meet the threshold hash (e.g., the first four characters of the hash value are not each zero), the miner starts again to provide another hash value. If the hash value meets the threshold hash (e.g., at least the first four characters of the hash value are each zero), the respective miner successfully created the next block that is to be added to the blockchain. Consequently, the respective miner's block is broadcast across the peer-to-peer network. All other miners cease work (because one miner was already successful), and all copies of the blockchain are updated across the peer-to-peer network to append the block to the blockchain. Each miner may be required to produce hundreds or thousands of hash values, before any one miner provides a qualifying hash value (e.g., at least the first four characters of the hash value are each zero).

In some cases, the DLS (e.g., blockchain system) can include one or more sidechains. A sidechain can be described as a blockchain that validates data from other blockchains. In some examples, a sidechain enables ledger assets (e.g., a digital currency, records of shares or other items, etc.) to be transferred between multiple blockchains. The blockchain may be a public blockchain, such that data stored on the blockchain is generally accessible. The blockchain may be a private (e.g., permissioned) blockchain, such that the stored data is accessible only to authorized individuals and/or processes on the blockchain.

The DLS provides a distributed data storage technology for securely transmitting any suitable type of information without requiring the control of a central authority. The DLS is a distributed database of transactions, repeated in an identical copy in multiple nodes that host the DLS. Cryptography can be used to ensure that the copies are identical and that no transaction is duplicated, and to enforce specific permissions for reading the stored data. The DLS can order and validate the transactions in the stored data to achieve the consensus according to different models and rules. For example, transactions can represent a transfer of information between two or more addresses within the network. The DLS can be implemented within the same company, multiple companies, on a public network, and/or on a permissioned network. Through use of the DLS, implementations avoid the need for the intermediation of a single, central authority.

In a traditionally implemented JV, the expenses in a plant (e.g., an oil and gas plant) are incurred and maintained by one partner entity, the operator. The expenses are reconciled, shared among the partners of the JV (described as cutback) as per the agreed equity stake, and sent to the partners at the end of the period (e.g., month) in the form of billing. Changes to the equity stake of a partner due to carry arrangements (e.g., partial, full, private), a new partner entering, or an existing partner leaving the agreement can cause delay in execution of the process and can raise multiple disputes between the operator and partners due to lack of visibility on the details of individual expenses, leading to delayed invoice settlement by the partners.

A JOA can be a formal contractual agreement that specifies conditions between stake holders on equity and overhead rates. The management of a JOA using previously available techniques can lead to various problems. Traditionally, there is difficulty in managing the changing equity stake of partners, and in managing changes to overhead rates with respect to to JOA and PSA agreements. With respect to expense recording, disputes between the operator and partners can arise due to lack of visibility into the details of individual expenses. With respect to cash call and/or forecast, the lack of visibility on breakup of cash calls and forecast amount can lead to questions, disputes, litigation, and/or delay in settlement of cash calls amounts. With respect to cutback and billing, the calculation and sharing of expenditure to partners may occur on a periodic basis at month end, thus leading to a lack of real time visibility into expenditures. The inability to send billings on time can lead to cash outstanding issues. With respect to equity adjustments, it may be difficult to manage different type of equities adjustments such as partial carries, full carries, private carries scenarios, and so forth. A large amount of effort may be involved in calculating and recording of accounting books and reconciliation of equity adjustments ledgers, which can lead to delay in sending and settlement of billings and/or invoices. Implementations provide a platform that addresses these issues, providing improvements and advantages over previously available solutions.

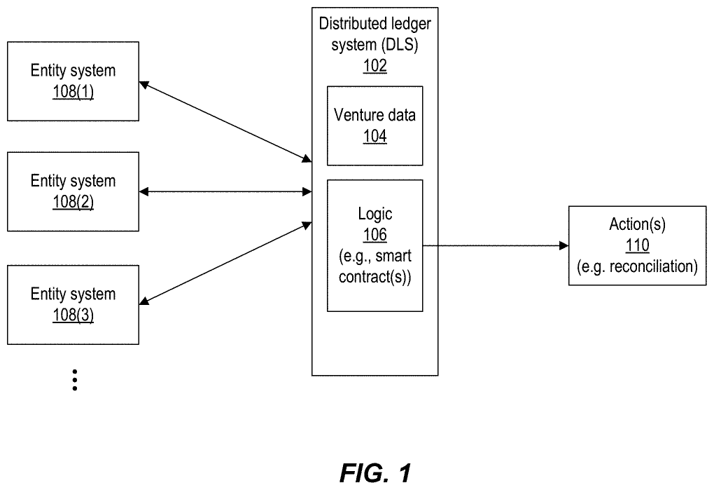

FIG. 1 depicts an example system for venture (e.g., JV) management, according to implementations of the present disclosure. As shown in the example of FIG. 1, the system can include a DLS 102. The DLS 102 can be a private DLS, and access to the private DLS can be controlled such that authorized entities are able to access the data stored on the DLS 102, but the general public may not be able to access the data. A private DLS can also be described as a permissioned DLS, given that access to the DLS can be permission-based and restricted to authorized entities that have been granted permission to access the DLS, such as stakeholders.

The DLS 102 can be hosted by multiple nodes, with each node including a computing device or cluster of computing devices with sufficient storage, processing, and/or network capacity to participate in the DLS 102. In some examples, the DLS 102 can be based on a version of a QuorumTM blockchain implementation.

The DLS 102 can store venture data 104 that includes records of data relevant to operation of the JV. In some implementations, the platform can include logic 106 such as one or more smart contracts. The logic 106 can execute on the DLS 102 and/or elsewhere. Based on the venture data 104, the logic 106 can perform action(s) 110, such as action(s) for reconciliation between entities. In some examples, the action(s) 110 can include generation of an invoice for payment from one entity to another. Generation of the invoice can include generating an electronic version of the invoice, and communicating the invoice over a network to the appropriate entity and/or its financial institution (e.g., bank). Generation of the invoice can also include sending a signal to a printing device to cause the printing device to generate a physical (e.g., paper) copy of the invoice that is suitable for mailing, reading, filing, or other actions.

The DLS 102 can be accessible by any suitable number of entity systems 108, each associated with an entity such as an operating entity, non-operating entity, auditor entity, and so forth. The entity system(s) 108 can be authorized to access the DLS 102 and add records to the venture data 104, and/or read records previously added to the venture data 104.

The DLS 102 can record various events such as the JOA itself, expenditures, and/or cash call posting details. A smart contract, and/or other executable logic 106, can perform an automatic calculation of overhead rates based on overhead type and/or cutback process. For example, the logic 106 can calculate expense sharing between partners and/or execution of equity adjustments between new or existing partners as per the newly agreed ratios. Such calculations can be performed in real time, with respect to changes in the venture data 104, thus removing disputes and discrepancies between operators and other partner entities and allowing on-time payments.

The DLS 102 can store details regarding the JOA governing the JV. The DLS 102 can also store the current and new/changed equity shares of partners without tampering. The DLS 102 can also provide recording, calculation of overhead, and/or cash call forecast. By using an intelligent algorithm in the smart contract(s) and/or other logic, implementations can calculate overhead automatically, and provide a CCL forecast amount with breakdown functionality in real time. With respect to cutback and billings, implementations can use an intelligent algorithm for automatic calculation of cutback on real time and/or daily basis. This can reduce the effort for reconciliation and auditing of billings due to the DLS 102 leading to on-time settlement of billings and/or invoices. Reconciliation can be performed as an automated process to determine allocation of revenues among partners, and determine which entities owe funds to which other entities. For equity adjustments, by using an intelligent algorithm maintenance of carry scenarios, implementations provide calculation and recording of accounting books on a real time basis. Reconciliation and auditing by partners can be performed on a real time basis with the DLS, provide for little or no delay in settlement of billings and/or invoices.

The venture data 104 stored on the DLS 102 can include, but is not limited to, one or more of the following: the JOA agreement; expenses tracking data; data describing results of automatic overhead and cutback calculation (e.g., on a real time basis); billings visible to (e.g., all) parties in real time; reconciliation and auditing data; and/or equity adjustments calculated automatically on a real time basis, thus avoiding delay in reporting and providing quick turn-around for cash settlements.

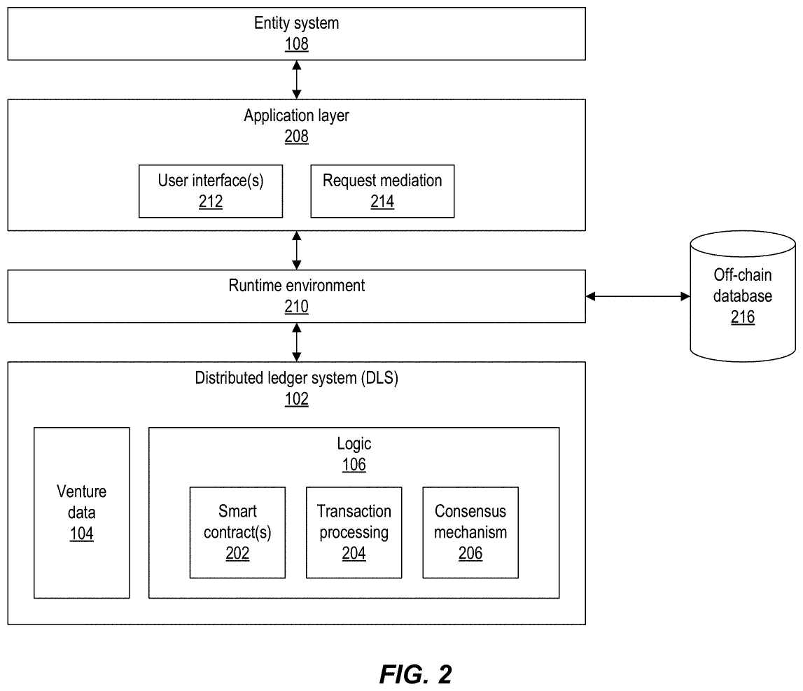

FIG. 2 depicts an example system for venture management, according to implementations of the present disclosure. The system can include the DLS 102, as described above. The DLS 102 can store venture data 104 describing a JV involving multiple entities. The DLS 102 can also include logic 106, such as one or more smart contracts 202, a transaction processing module 204, and/or a consensus mechanism module 206.

An entity system 108, including one or more computing devices that are operated by and/or otherwise associated with an entity, can communicate with the DLS 102 via an application layer 208 and a runtime environment 210. The application layer 208 can be implemented using Angular.js, in some implementations. The application layer 208 can include one or more user interfaces 212, and/or module(s) 214 to request mediation between the entity system 108 and the runtime environment 210, such as the send requests and receive requests. The runtime environment 210 can be implemented using a version of Node.js, in some implementations. The runtime environment 210 can store on-chain data in the DLS 102, e.g., as venture data 104. In some implementations, the runtime environment 210 can also communicate with an off-chain database 216 and store off-chain data in the database 216. For example, the database 216 can be an instance of MongoDB.

In some implementations, the DLS 102 can be implemented using a version of the Quorum blockchain. The smart contract(s) 202 can include an intelligent algorithm that enforces governing rules and/or constraints on the relationship(s) of the JV. For example, the smart contract(s) 202 can enforce the terms of the JOA between the entities.

The application layer 208 (e.g., Angular.js) can be used to create a user interface layer of interface(s) 212. The layer 208 can send requests to the server for processing, and show the information received from the server in the interface(s) 212. The environment 210 (e.g., Nodejs) can process the information received from the UI, and in some instances store data to the off-chain database 216. The environment 210 can also access the DLS 102 to store on-chain data as venture data 104. In some examples, critical data can be stored as on-chain data. The DLS 102 (e.g., Quorum™) can be an enterprise version of the Ethereum™ blockchain, and/or can be a permissioned blockchain platform. The plant operator entity and non-operator entities can reside as nodes in the DLS 102.

The DLS 102, environment 210, and layer 208 can collectively be described as the platform that is accessible by entity system(s) 108 for various entities involved in the JOA. Access to the DLS 102 can be limited to those entities that are authorized, such as entities participating in a particular JOA. In some instances, each JOA can have a separate instance of venture data 104 and/or logic 106 that is particularly associated with the JOA, and that executes actions related to the particular JOA.

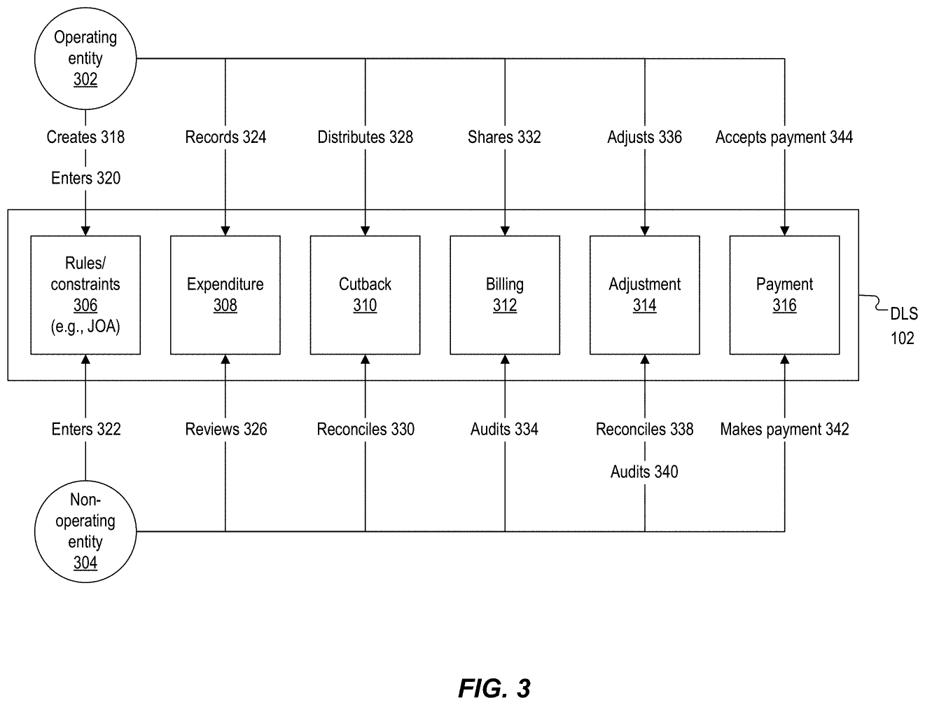

FIG. 3 depicts an example system for venture management including access to various types of records stored on DLS 102, according to implementations of the present disclosure. Implementations use the DLS 102 to provide visibility into data such as equity shares, provide real time tracking of expenditures, cash call forecast, and/or cutback processes using smart contracts to calculate equity adjustments on real time basis. Different roles of entities can have different permissions to perform different operations on the DLS 102. In some instances, an auditor entity can view all the data stored on the DLS 102 for a particular JOA.

As shown in the example of FIG. 3, the DLS 102 can include logic 106 such as various intelligent algorithm calculation modules that are associated with different types of data that can be written to the DLS 102. Such modules can include, but are not limited to, modules for rules and/or constraints 306 (e.g., the JOA itself), expenditure 308, cutback 310, billing 312, adjustment 314, and/or payment 316. Different types of entities, such as an operating entity 302 and/or non-operating entity 304, can access the modules to create and/or access data on the DLS according to permissions associated with their entity type. For example, the operating entity 302 can do one or more of the following: create (318) the rules/constraints by specifying the JOA, record (324) expenditures, distribute (328) cutbacks, share (332) billings, adjust (336) adjustments, and/or accept (344) payments. The non-operating entity 304 can do one or more of the following: review (326) expenditures, reconcile (330) cutbacks, audit (334) billings, reconcile (338) and/or audit (340) adjustments, and/or make (342) payments. The operating entity 302 and non-operating entity 304 can also access the rules/constraints module 306 to enter (320 and 322) into the JOA. Access to the module(s) and/or data created through such access can be recorded as venture data 104 on the DLS 102.

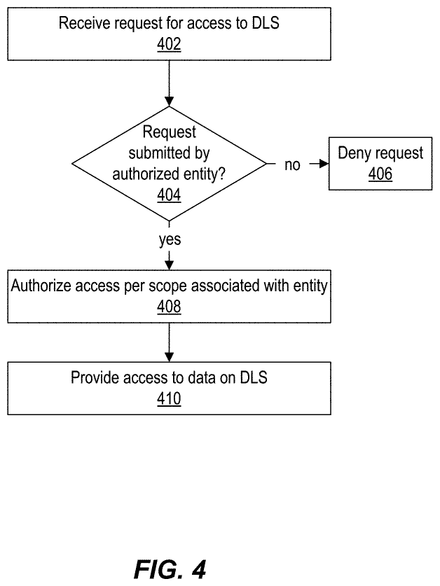

FIG. 4 depicts a flow diagram of an example process for venture management, according to implementations of the present disclosure. Operations of the process can be performed by the logic 106 (e.g., smart contract(s)) and/or other software module(s) executing on the DLS 102 or elsewhere.

A request can be received (402) for access to the DLS. A determination can be made (404) whether the request was sent by an authorized entity, such as an operating entity or non-operating entity authorized to access the private DLS as described above. If not, the request can be denied (406). If so, the access is authorized (408), and the requestor is permitted to access the data stored on the DLS (410) according to the scope of access that is authorized with the requesting entity, as described above.

The implementations described herein alleviate challenges and/or prevent grievances with respect to various sub-processes of a JV process. For example, with respect to master data, implementations enable multiple equity groups can be active.

With respect to expenses recording, implementations provide that expenses recording can be visible on a real time basis as and when the expense is incurred.

With respect to cutback and/or apportionment of expenditure, implementations provide that expenditures incurred by operator are apportioned to partners in their equity ratio on a real time basis.

With respect to cash calls, implementations provide no room for gold plating, and that information gathered from different departments is visible in real time and gives the partners the opportunity to plan the cash in advance for the JV.

With respect to settlement of cash (e.g., cash calls), implementations provide that disputes can be settled as and when the query is raised by partners, that adjustments can be made on an online basis and reconciled, and that cash payouts can be made by partners on time.

With respect to billing preparation, expenditure statement, and/or cash call statement, implementations provide that reconciliation can be done by partners in real time, adjustments can be posted or action taken as and when grievances are raised, and billings are produced in real time with no deviations and disputes.

With respect to billing communication, implementations provide that billings can be retrieved by parties on a real time basis.

With respect to equity adjustments, such as a new partner entering the JOA, a partner leaving the JOA, and/or existing partners changing their equity ratio, implementations provide that both old and new equity sharing ratios are active at the same time, equity adjustment happens with a retrospective date and the accounting journals can be adjusted from old to new equity sharing ratio on a real time basis, and billings reflect new equity on a real time basis.

With respect to equity adjustments such as carry arrangements, partial or full private carries of single partner, by using an intelligent algorithm, implementations can create one equity set up differently for carrying and non-carrying partners and produce single billings. Equity adjustments can happen with a retrospective date and the accounting journals can be adjusted from old to new equity sharing ratio on a real time basis. Billings can reflect new equity on a real time basis.

As an example scenario, a JOA can be an agreement in which partners agree to develop, for a finite time, a new entity and new assets by contributing equity and consequently share revenues, expenses, and assets. In this example, the JOA parties are the operator and the non-operating partners. The operator (operating partner) can: plan future activities of the venture, run day-to-day activities of the venture, maintain accounting records for the venture, report venture activity to partners, and report profit or loss to the partners. The non-operating partners can maintain accounting records for their own share of the venture, and settle accounts with the operating partner, according to the conditions of the venture. All such activities can be performed through access to the DLS and/or through execution of the logic, as described above, providing substantial advantages over traditional, previously available JOA management techniques.

As described above, the platform can include various components for master data setup, expenditure recording, month-end activities (e.g., overhead calculation, allocations, revaluations, settlements, etc.), cash calls, cutback, billings, and so forth. In some examples, the permissioned DLS can be accessed by JOA partners (e.g., operating and non-operating partners) and auditors with different levels of access to request different actions be performed, as described in Table 1 below.

TABLE 1

| | entity | | | | | | |
|---|---|---|---|---|---|---|---|
| | Master | | Month | | | | |
| | Data | Expenditure | end | Cash call | | | |
| Party | setup | recording | allocation | postings | Cutback | Billings | Payments |
| Operator | Write | Write and | Write and | Write | Write | Write | Write and |
| | and read | read access | read | and read | and read | and read | read |
| | access | | access | access | access | access | access |
| Non- | Read | Read access | Read | Read | Read | Read | Write and |
| operating | access | | access | access | access | access | read |
| partners | | | | | | | access |
| Auditors | Read | Read access | Read | Read | Read | Read | Read |
| | access | | access | access | access | access | access |

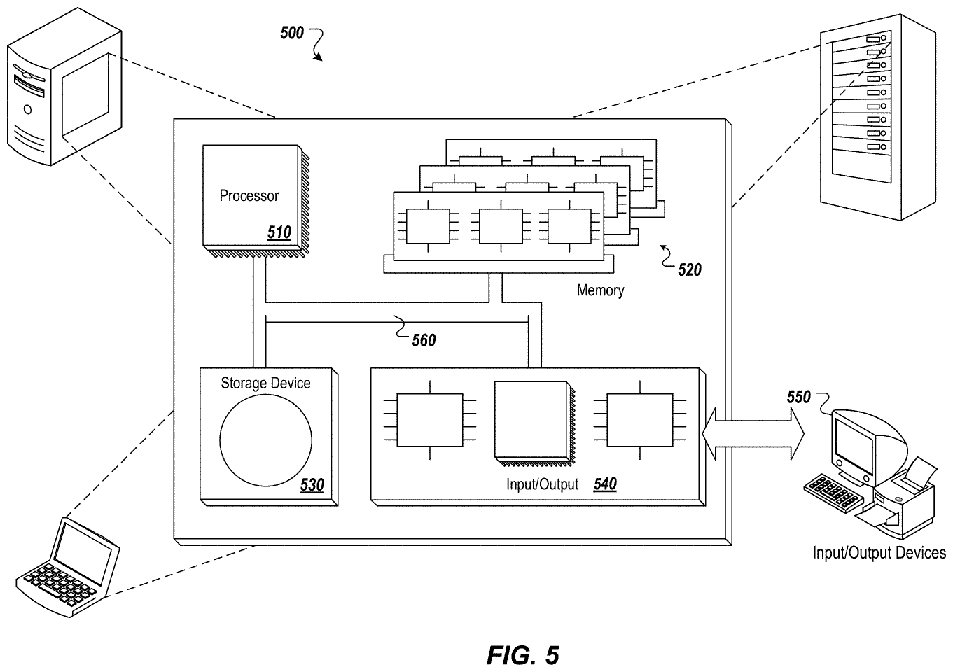

FIG. 5 depicts an example computing system, according to implementations of the present disclosure. The system 500 may be used for any of the operations described with respect to the various implementations discussed herein. For example, the system 500 may be included, at least in part, in one or more of the node(s) that host the DLS 102, the entity system(s) 108, and/or other computing device(s) or system(s) described herein. The system 500 may include one or more processors 510, a memory 520, one or more storage devices 530, and one or more input/output (I/O) devices 550 controllable via one or more I/O interfaces 540. The various components 510, 520, 530, 540, or 550 may be interconnected via at least one system bus 560, which may enable the transfer of data between the various modules and components of the system 500.

The processor(s) 510 may be configured to process instructions for execution within the system 500. The processor(s) 510 may include single-threaded processor(s), multi-threaded processor(s), or both. The processor(s) 510 may be configured to process instructions stored in the memory 520 or on the storage device(s) 530. For example, the processor(s) 510 may execute instructions for the various software module(s) described herein. The processor(s) 510 may include hardware-based processor(s) each including one or more cores. The processor(s) 510 may include general purpose processor(s), special purpose processor(s), or both.

The memory 520 may store information within the system 500. In some implementations, the memory 520 includes one or more computer-readable media. The memory 520 may include any number of volatile memory units, any number of non-volatile memory units, or both volatile and non-volatile memory units. The memory 520 may include read-only memory, random access memory, or both. In some examples, the memory 520 may be employed as active or physical memory by one or more executing software modules.

The storage device(s) 530 may be configured to provide (e.g., persistent) mass storage for the system 500. In some implementations, the storage device(s) 530 may include one or more computer-readable media. For example, the storage device(s) 530 may include a floppy disk device, a hard disk device, an optical disk device, or a tape device. The storage device(s) 530 may include read-only memory, random access memory, or both. The storage device(s) 530 may include one or more of an internal hard drive, an external hard drive, or a removable drive.

One or both of the memory 520 or the storage device(s) 530 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 500. In some implementations, the CRSM may include a data store that provides storage of computer-readable instructions or other information in a non-transitory format. The CRSM may be incorporated into the system 500 or may be external with respect to the system 500. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some examples, the processor(s) 510 and the memory 520 may be supplemented by, or incorporated into, one or more application-specific integrated circuits (ASICs).

The system 500 may include one or more I/O devices 550. The I/O device(s) 550 may include one or more input devices such as a keyboard, a mouse, a pen, a game controller, a touch input device, an audio input device (e.g., a microphone), a gestural input device, a haptic input device, an image or video capture device (e.g., a camera), or other devices. In some examples, the I/O device(s) 550 may also include one or more output devices such as a display, LED(s), an audio output device (e.g., a speaker), a printer, a haptic output device, and so forth. The I/O device(s) 550 may be physically incorporated in one or more computing devices of the system 500, or may be external with respect to one or more computing devices of the system 500.

The system 500 may include one or more I/O interfaces 540 to enable components or modules of the system 500 to control, interface with, or otherwise communicate with the I/O device(s) 550. The I/O interface(s) 540 may enable information to be transferred in or out of the system 500, or between components of the system 500, through serial communication, parallel communication, or other types of communication. For example, the I/O interface(s) 540 may comply with a version of the RS-232 standard for serial ports, or with a version of the IEEE 1284 standard for parallel ports. As another example, the I/O interface(s) 540 may be configured to provide a connection over Universal Serial Bus (USB) or Ethernet. In some examples, the I/O interface(s) 540 may be configured to provide a serial connection that is compliant with a version of the IEEE 1394 standard.

The I/O interface(s) 540 may also include one or more network interfaces that enable communications between computing devices in the system 500, or between the system 500 and other network-connected computing systems. The network interface(s) may include one or more network interface controllers (NICs) or other types of transceiver devices configured to send and receive communications over one or more communication networks using any network protocol.

Computing devices of the system 500 may communicate with one another, or with other computing devices, using one or more communication networks. Such communication networks may include public networks such as the internet, private networks such as an institutional or personal intranet, or any combination of private and public networks. The communication networks may include any type of wired or wireless network, including but not limited to local area networks (LANs), wide area networks (WANs), wireless WANs (WWANs), wireless LANs (WLANs), mobile communications networks (e.g., 3G, 4G, Edge, etc.), and so forth. In some implementations, the communications between computing devices may be encrypted or otherwise secured. For example, communications may employ one or more public or private cryptographic keys, ciphers, digital certificates, or other credentials supported by a security protocol, such as any version of the Secure Sockets Layer (SSL) or the Transport Layer Security (TLS) protocol.

The system 500 may include any number of computing devices of any type. The computing device(s) may include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a system on a chip (SoC), a system in a package (SiP), and so forth. Although examples herein may describe computing device(s) as physical device(s), implementations are not so limited. In some examples, a computing device may include one or more of a virtual computing environment, a hypervisor, an emulation, or a virtual machine executing on one or more physical computing devices. In some examples, two or more computing devices may include a cluster, cloud, farm, or other grouping of multiple devices that coordinate operations to provide load balancing, failover support, parallel processing capabilities, shared storage resources, shared networking capabilities, or other aspects.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor may receive instructions and data from a read only memory or a random access memory or both. Elements of a computer can include a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be realized on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be realized in a computing system that includes a back end component, e.g., as a data server, or that includes a middleware component, e.g., an application server, or that includes a front end component, e.g., a client computer having a graphical user interface or a web browser through which a user may interact with an implementation, or any appropriate combination of one or more such back end, middleware, or front end components. The components of the system may be interconnected by any appropriate form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

1. A method performed by at least one processor, the method comprising:
receiving, by the at least one processor, at a venture management platform, venture data generated by an entity system in communication with the venture management platform, the venture data describing one or more events associated with a venture that involves multiple entities including an entity that operates the entity system;
storing, by the at least one processor, the venture data on a permissioned distributed ledger system (DLS) of the venture management platform, the DLS including multiple host node devices; and
executing, by the at least one processor, at least one smart contract that is a component of the venture management platform, the at least one smart contract performing at least one action based on the venture data and based on at least one constraint specified by an agreement that governs the venture and that is stored on the DLS.

2. The method of claim 1, wherein storing the venture data on the DLS is based at least in part on determining that the entity is authorized to access the venture management platform.

3. The method of claim 1, wherein:
the venture data is communicated with a request, from the entity system, to perform the at least one action; and
performing the at least one action is based at least partly on determining that the entity is of an entity type that is authorized to request the at least one action.

4. The method of claim 3, wherein the entity type is:
an operating entity involved in the venture;
a non-operating entity involved in the venture; or
an auditor of the venture.

5. The method of claim 1, wherein the at least one smart contract executes on the DLS.

6. The method of claim 1, wherein the at least one action includes a reconciliation between the entity and at least one other entity involved in the venture.

7. The method of claim 1, wherein the venture management platform further includes an application layer in communication with the entity system, and a runtime environment that mediates communications between the application layer and the DLS.

8. A system comprising:
at least one processor; and
a memory communicatively coupled to the at least one processor, the memory storing instructions which, when executed, cause the at least one processor to perform operations comprising:
receiving, at a venture management platform, venture data generated by an entity system in communication with the venture management platform, the venture data describing one or more events associated with a venture that involves multiple entities including an entity that operates the entity system;
storing the venture data on a permissioned distributed ledger system (DLS) of the venture management platform, the DLS including multiple host node devices; and
executing at least one smart contract that is a component of the venture management platform, the at least one smart contract performing at least one action based on the venture data and based on at least one constraint specified by an agreement that governs the venture and that is stored on the DLS.

9. The system of claim 8, wherein storing the venture data on the DLS is based at least in part on determining that the entity is authorized to access the venture management platform.

10. The system of claim 8, wherein:
the venture data is communicated with a request, from the entity system, to perform the at least one action; and
performing the at least one action is based at least partly on determining that the entity is of an entity type that is authorized to request the at least one action.

11. The system of claim 10, wherein the entity type is:
an operating entity involved in the venture;
a non-operating entity involved in the venture; or
an auditor of the venture.

12. The system of claim 8, wherein the at least one smart contract executes on the DLS.

13. The system of claim 8, wherein the at least one action includes a reconciliation between the entity and at least one other entity involved in the venture.

14. The system of claim 8, wherein the venture management platform further includes an application layer in communication with the entity system, and a runtime environment that mediates communications between the application layer and the DLS.

15. One or more computer-readable storage media storing instructions which, when executed, cause at least one processor to perform operations comprising:
receiving, at a venture management platform, venture data generated by an entity system in communication with the venture management platform, the venture data describing one or more events associated with a venture that involves multiple entities including an entity that operates the entity system;
storing the venture data on a permissioned distributed ledger system (DLS) of the venture management platform, the DLS including multiple host node devices; and
executing at least one smart contract that is a component of the venture management platform, the at least one smart contract performing at least one action based on the venture data and based on at least one constraint specified by an agreement that governs the venture and that is stored on the DLS.

16. The one or more computer-readable storage media of claim 15, wherein storing the venture data on the DLS is based at least in part on determining that the entity is authorized to access the venture management platform.

17. The one or more computer-readable storage media of claim 15, wherein:
the venture data is communicated with a request, from the entity system, to perform the at least one action; and
performing the at least one action is based at least partly on determining that the entity is of an entity type that is authorized to request the at least one action.

18. The one or more computer-readable storage media of claim 15, wherein the at least one smart contract executes on the DLS.

19. The one or more computer-readable storage media of claim 15, wherein the at least one action includes a reconciliation between the entity and at least one other entity involved in the venture.

20. The one or more computer-readable storage media of claim 15, wherein the venture management platform further includes an application layer in communication with the entity system, and a runtime environment that mediates communications between the application layer and the DLS.
